(19) United States
(12) Patent Application Publication
(10) Pub. No.: US 2024/0094665 A1
(43) Pub. Date: Mar. 21, 2024

(54) BELT UNIT, FIXING DEVICE, AND IMAGE FORMING APPARATUS

(71) Applicant: FUJIFILM Business Innovation Corp., Tokyo (JP)

(72) Inventors: Kotaro ARAKI, Kanagawa (JP); Shogo KAMIYA, Kanagawa (JP); Shingo AKIYAMA, Kanagawa (JP)

(73) Assignee: FUJIFILM Business Innovation Corp., Tokyo (JP)

(21) Appl. No.: 18/181,187

(22) Filed: Mar. 9, 2023

(30) Foreign Application Priority Data
Sep. 16, 2022 (JP) 2022-147967

(51) Int. Cl. G03G 15/20

(52) U.S. Cl. CPC G03G 15/2053

(57) ABSTRACT

A belt unit includes: a belt-shaped member being endless; and a support member that supports the belt-shaped member and rotates, the support member having a rotating shaft that tilts in: a tilt direction having a component in a first direction intersecting a bisector of a central angle of a wrapping range where the belt-shaped member is wrapped around the support member and a component in a second direction where the belt-shaped member elongates and contracts; and a direction where extent of shifting of the belt-shaped member to one side in the width direction of the belt-shaped member is reduced.

### CROSS-REFERENCE TO RELATED APPLICATIONS

This application is based on and claims priority under 35 USC 119 from Japanese Patent Application No. 2022-147967 filed Sep. 16, 2022.

### BACKGROUND

### (i) Technical Field

The present disclosure relates to a belt unit, a fixing device, and an image forming apparatus.

### (ii) Related Art

Japanese Unexamined Patent Application Publication No. 2018-045255 (refer to paragraphs to [0031]) and Japanese Unexamined Patent Application Publication No. 2021-056334 (refer to paragraphs to [0075]) disclose known techniques regarding fixing devices in image forming apparatuses for fixing unfixed toner transferred onto a medium.

In Japanese Unexamined Patent Application Publication No. 2018-045255, a fixing belt module (61) including a fixing belt (610) stretched by a first stretching roller (612) and a second stretching roller (613) and a load receiving member (615) is described. There is described a technique for correcting meandering and lateral shifting of the fixing belt (610). In the fixing belt module (61) of Japanese Unexamined Patent Application Publication No. 2018-045255, such correction is performed by shaking both ends of the second stretching roller (613), around a center portion (613A) in the axial direction of the second stretching roller (613), in an elongation and contraction direction of the fixing belt (610), which is a direction where the tension of the fixing belt (610) is increased and decreased, that is, a direction of a perpendicular bisector of the bisector of a wrapping angle.

In Japanese Unexamined Patent Application Publication No. 2021-056334, there is described a technique for correcting meandering and lateral shifting of a fixing belt (314) by using a steering unit including: a heating roller (312) for heating the fixing belt (314); and a belt-tension adjustment portion (36). Such correction is performed by, with one end in the axial direction of the steering unit being fixed, tilting the other end side of the steering unit. In Japanese Unexamined Patent Application Publication No. 2021-056334, a steering section (35) moves the heating roller (312) in a direction of a perpendicular bisector relative to an elongation and contraction direction of the fixing belt (314) that is a direction where the tension of the fixing belt (314) is increased and decreased.

### SUMMARY

Aspects of non-limiting embodiments of the present disclosure relate to improving the capability to correct shifting of a belt member to one side in the width direction thereof, compared with when a support member is tilted only in a direction of a perpendicular bisector of the bisector of the central angle of a wrapping range of the belt-shaped member.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a belt unit including: a belt-shaped member being endless; and a support member that supports the belt-shaped member and rotates, the support member having a rotating shaft that tilts in: a tilt direction having a component in a first direction intersecting a bisector of a central angle of a wrapping range where the belt-shaped member is wrapped around the support member and a component in a second direction where the belt-shaped member elongates and contracts; and a direction where extent of shifting of the belt-shaped member to one side in the width direction of the belt-shaped member is reduced.

### BRIEF DESCRIPTION OF THE DRAWINGS

An exemplary embodiment of the present disclosure will be described in detail based on the following figures, wherein:

FIG. 1 is an overall view illustrating an image forming apparatus of Example 1 of the present disclosure;

FIG. 2 illustrates a portion of a frame part of a fixing device of Example 1;

FIG. 3 illustrates the configuration in FIG. 2 as viewed in direction III in FIG. 2;

FIGS. 4A, 4B, and 4C illustrate a steering device of Example 1, that is, FIG. 4A illustrates a standby position, FIG. 4B illustrates an elongation-side maximum position, and FIG. 4C illustrates a contraction-side maximum position;

FIG. 5 illustrates an experimental example;

FIG. 6 illustrates a portion of a frame part of a fixing device of Example 2 and corresponds to FIG. 2 of Example 1; and

FIG. 7 illustrates a portion of a frame part of a fixing device of Example 3 and corresponds to FIG. 2 of Example 1.

### DETAILED DESCRIPTION

Next, Examples 1 to 3, which are specific examples of an exemplary embodiment of the present disclosure, will be described with reference to the drawings; however, the present disclosure is not limited to the following examples.

Note that, for facilitating understanding of the following description, in the drawings, the front-back direction is referred to as the X-axis direction, the left-right direction is referred to as the Y-axis direction, the up-down direction is referred to as the Z-direction. Directions or sides represented by arrows X, −X, Y, −Y, Z, and −Z are referred to as frontward, backward, rightward, leftward, upward, and downward, respectively, or a front side, a back side, a right side, a left side, an upper side, and a lower side, respectively.

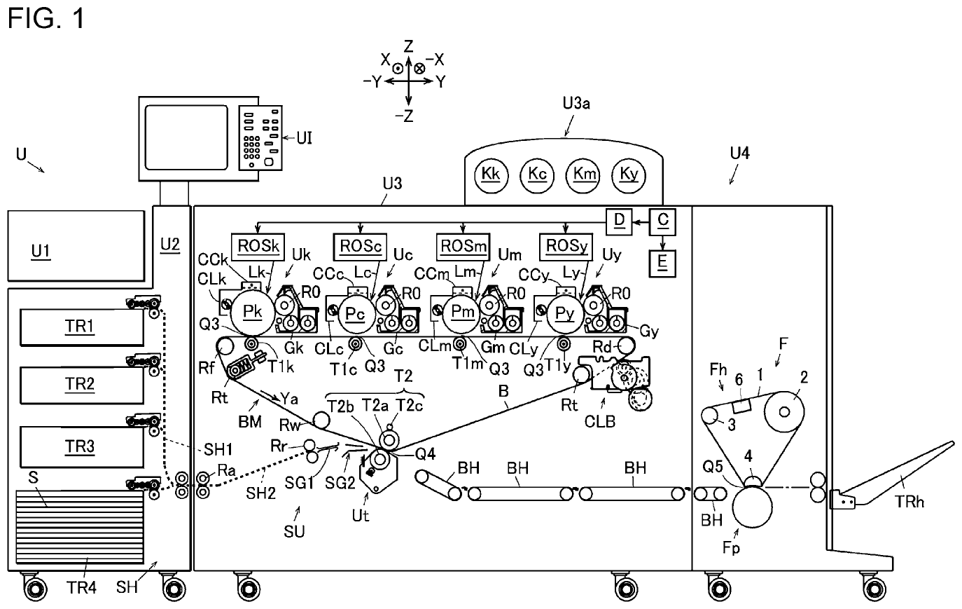

In the drawings, a symbol of an encircled solid filled circle represents an arrow directed from the undersurface toward the front surface of the paper on which FIG. 1 is illustrated, and a symbol of an encircled cross represents an arrow directed from the front surface toward the undersurface of the paper of FIG. 1.

Note that, in the following description with reference to the drawing, illustration of members that are not required in the description herein will appropriately be omitted for facilitating understanding.

### Example 1

FIG. 1 is an overall view illustrating an image forming apparatus of Example 1 of the present disclosure.

In FIG. 1, a copier U, which is an example of an image forming apparatus, includes: an operation section UI; a scanner device U1, which is an example of an image reading device; a paper feeding device U2; a printer section U3, which is an example of an image recording device; and a paper discharge section U4.

The operation section UI includes a power button, a copy start key, a copy-paper-count set key, a numeric keypad, or other buttons or keys, which are an example of an input part, and includes a display part or other parts.

The scanner device U1 reads and converts a document (not illustrated) into image information and inputs the image information to the printer section U3.

The paper feeding device U2 includes plural paper feeding trays TR1 to TR4, which are each an example of a paper feeding part. Sheets of recording paper S, which are each an example of a medium, are accommodated in the paper feeding trays TR1 to TR4. A paper feeding path SH1, which is an example of a transport path for a medium, extends from each of the paper feeding trays TR1 to TR4 toward the printer section U3.

In FIG. 1, the printer section U3 includes, for example, a controller C and a power supply circuit E that supplies power to each of the constituents of the printer section U3 under the control of the controller C. The controller C receives the image information of a document read by the scanner device U1 or the image information transmitted from a personal computer (not illustrated), which is an example of an information transmitting apparatus connected to the copier U.

The controller C processes such received image information into information for printing in yellow (Y), magenta (M), cyan (C), and black (K) and outputs the processed information to a laser driving circuit D, which is an example of a driving circuit of a latent image writing device. The laser driving circuit D outputs, at a predetermined time, laser driving signals that are input by the controller C, to exposure devices ROSy, ROSm, ROSc, and ROSk, which are examples of latent image forming members of the respective colors.

Image holder units Uy (for Y), Um (for M), Uc (for C), and Uk (for K) are arranged below the exposure devices ROSy, ROSm, ROSc, and ROSk, respectively.

In FIG. 1, the image holder unit Uk for black (K) includes: a photoconductor drum Pk, which is an example of an image holding member; a charging corotron CCk, which is an example of a charger; and a photoconductor cleaner CLk, which is an example of a cleaner for the image holding member. Similarly, the other image holder units Uy (for Y), Um (for M), and Uc (for C) also include: photoconductor drums Py, Pm, and Pc; charging corotrons CCy, CCm, and CCc; and photoconductor cleaners CLy, CLm, and CLc, respectively.

Note that, in Example 1, the photoconductor drum Pk (for K) that is used with high frequency and whose surface tends to be worn out heavily has a diameter larger than the diameters of the photoconductor drums Py, Pm, and Pc for the other colors, thereby being capable of a high rotation speed operation and having a longer life.

The photoconductor drums Py, Pm, Pc, and Pk are uniformly charged by the charging corotrons CCy, CCm, CCc, and CCk, respectively, and electrostatic latent images are then formed on surfaces of the photoconductor drums Py to Pk by laser beams Ly, Lm, Lc, and Lk, which are examples of latent image writing light output from the exposure devices ROSy, ROSm, ROSc, and ROSk. The electrostatic latent images on the surfaces of the photoconductor drums Py to Pk are developed into toner images of the respective colors: yellow (Y), magenta (M), cyan (C), and black (K) by developing rollers RO, which are examples of developing members provided in developing devices Gy, Gm, Gc, and Gk, which are each an example of a developing unit.

In a first-transfer region Q3, the toner images on the surfaces of the photoconductor drums Py to Pk are transferred in order, while superimposed, onto an intermediate transfer belt B, which is an example of an intermediate transfer member and an example of an image holding member, by first-transfer rollers T1y, T1m, T1c, and T1k, respectively, which are each an example of a first-transfer member. Accordingly, a multicolor image, which is commonly referred to as a color image, is formed on the intermediate transfer belt B. The color image formed on the intermediate transfer belt B is transported to a second-transfer region Q4.

Note that, when only black image data is given, only the photoconductor drum Pk and the developing device Gk for black (K) are used, and only a toner image in black is formed.

After the first transfer, residual toner remaining on the surfaces of the photoconductor drums Py, to Pk is cleaned by the respective photoconductor cleaners CLy, CLm, CLc, and CLk.

Toner image forming sections Uy+Gy, Um+Gm, Uc+Gc, and Uk+Gk, which are each an example of a visible image forming section, are constituted by the respective image holder units Uy to Uk and the respective developing devices Gy to Gk.

A toner dispenser U3a, which is an example of a replenishing unit, is disposed in an upper portion of the printer section U3, and toner cartridges Ky, Km, Kc, and Kk, which are each an example of a toner storage, are removably mounted in the toner dispenser U3a. When toner is consumed at the developing devices Gy to Gk as image formation proceeds, toner is supplied from the toner cartridges Ky to Kk to the respective developing devices Gy to Gk.

The intermediate transfer belt B disposed below the photoconductor drums Py to Pk is stretched by: an intermediate driving roller Rd, which is an example of a driving member of the intermediate transfer member; an intermediate tension roller Rt, which is an example of a tension applying member that applies tension to the intermediate transfer belt B; an intermediate steering roller Rw, which is an example of a first lateral-shifting correction member that corrects lateral shifting and meandering of the intermediate transfer belt B; plural intermediate idler rollers Rf, which are each an example of a driven member; and a backup roller T2a, which is an example of a facing member relative to the second-transfer region. The intermediate transfer belt B is supported so as to be moved in a rotating manner in a direction of arrow Ya by being driven by the intermediate driving roller Rd.

A belt module BM, which is an example of an intermediate transfer device, is constituted by, for example, the intermediate driving roller Rd, the intermediate tension roller Rt, the intermediate steering roller Rw, the intermediate idler rollers Rf, the backup roller T2a, the first-transfer rollers T1y to T1k, the intermediate transfer belt B. Note that the belt module BM of Example 1 is constituted by a unit that is removable and replaceable relative to the printer section U3.

A second-transfer unit Ut, which is an example of a transfer transport unit, is disposed below the backup roller T2a. The second-transfer unit Ut includes a second-transfer roller T2b, which is an example of a transfer member. The second-transfer roller T2b is disposed so as to face the backup roller T2a. The second-transfer region Q4 is defined by a region where the second-transfer roller T2b faces the intermediate transfer belt B. In addition, a contact roller T2c, which is an example of a contact member for voltage application, is in contact with the backup roller T2a. At a predetermined time, a second-transfer voltage having the same polarity as the charging polarity of the toner is applied to the contact roller T2c from the power supply circuit E controlled by the controller C.

The above-described rollers T2a to T2c constitute a second-transfer device T2, which is an example of a second-transfer member. In addition, the intermediate transfer belt B, the first-transfer rollers T1y to T1k, and the second-transfer device T2, for example, constitute a transfer device B+T1+T2, which is an example of a transfer unit.

A sheet transport path SH2 is disposed below the belt module BM. The recording paper S that has been fed from the paper feeding path SH1 of the paper feeding device U2 is transported by a transport roller Ra, which is an example of a transport member, to the sheet transport path SH2. The recording paper S on the sheet transport path SH2 is sent by a registration roller Rr, which is an example of a sending member, at a timing when a toner image is transported toward the second-transfer region Q4, and the recording paper S is transported to the second-transfer region Q4 while guided by paper guides SG1 and SG2, which are each an example of a medium guide member.

When passing through the second-transfer region Q4, the toner image on the intermediate transfer belt B is transferred onto the recording paper S by the second-transfer device T2. Note that, in the case of a color image, the toner images that are first-transferred, while superposed, onto a surface of the intermediate transfer belt B are second-transferred collectively onto the recording paper S.

The intermediate transfer belt B after performing second transfer is cleaned by a belt cleaner CLB, which is an example of a cleaning member for the intermediate transfer member.

The recording paper S on which a toner image has been second-transferred is sent to a medium transport belt BH, which is an example of the transport member. The medium transport belt BH transports the recording paper S to a fixing device F. The fixing device F, which is an example of a fixing device, includes a heating unit Fh, which is an example of a heating unit, and a pressing roller Fp, which is an example of a pressing member, and a region where the heating unit Fh and the pressing roller Fp face one another defines a fixing region Q5.

The toner image on the recording paper S is heated and fixed by the fixing device F when passing through the fixing region Q5. The recording paper S to which the toner image has been fixed at the fixing device F is discharged onto a discharge tray TRh, which is an example of a discharge member.

The above-described paths denoted by reference signs SH1 and SH2, for example, constitute a sheet transport path SH. In addition, the above-described elements denoted by reference signs SH, Ra, Rr, SG1, SG2, and BH, for example, constitute a paper transport device SU.

### Description of Fixing Device

In FIG. 1, the heating unit Fh of Example 1, which is an example of a belt unit, includes a fixing belt 1 being endless, which is an example of a belt-shaped member. The fixing belt 1 of Example 1 is supported by: a heat generating roller 2, which is an example of a heating member and an example of a heat generator; a steering roller 3, which is an example of a support member; and a fixing pad 4, which is an example of a facing member. The heat generating roller 2 generates heat and thus heats the fixing belt 1 during an image forming operation. When a lateral shift of the fixing belt 1 is detected, the steering roller 3 is tilted to correct such lateral shifting. With the fixing pad 4, the fixing belt 1 faces the pressing roller Fp in the fixing region Q5. In addition, a lubricating wick 6, which is an example of a lubricating member and an example of a supply member, is disposed on the inner surface side of the fixing belt 1. The lubricating wick 6 supplies the inner surface of the fixing belt 1 with silicon oil, which is an example of a lubricant for lubricating the fixing belt 1 and the fixing pad 4.

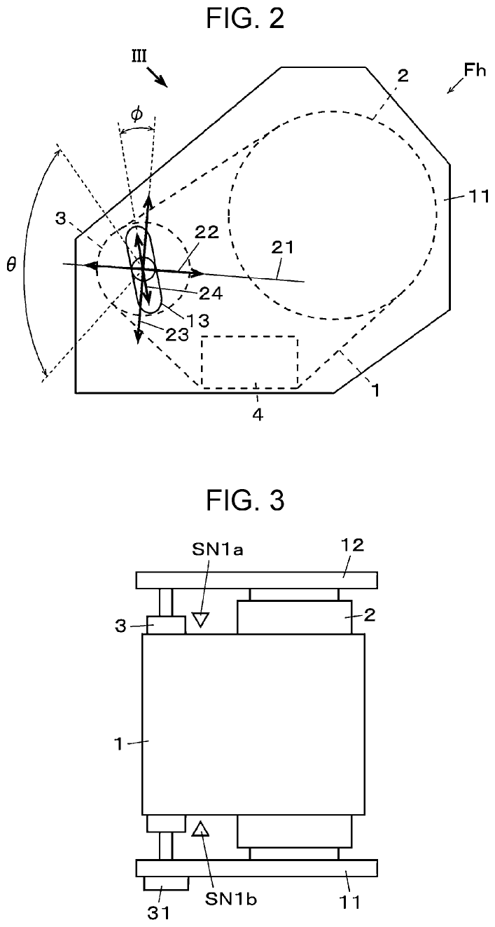

FIG. 2 illustrates a portion of a frame part of the fixing device of Example 1.

FIG. 3 illustrates the configuration in FIG. 2 as viewed in direction III in FIG. 2.

In FIG. 2 and FIG. 3, the heating unit Fh of Example 1 is provided with frames 11 and 12, which are each an example of a frame body, at both the front and back ends. The frame 11 on the front side and the frame 12 on the back side support, for example, the heat generating roller 2 and both end portions of the fixing pad 4. A front end portion of a rotating shaft 3a of the steering roller 3 is supported by the frame 11 on the front side so as to rotate and move along a guide hole part 13, which is an example of a guide part. The frame 12 on the back side also has a guide hole part, which is not illustrated, similar to the guide hole part 13 of the frame 11 on the front side, and a back end portion of the rotating shaft 3a of the steering roller 3 is supported by the frame 12 so as to rotate and move along the guide hole part. Note that, although only the frame 11 on the front side and the guide hole part 13 thereof and a front portion of the steering roller 3 will be described in the following description, a back portion of the steering roller 3 is configured in a similar manner, thereby not being described.

In FIG. 2, in Example 1, the fixing belt 1 is wrapped around the steering roller 3 in a range of a wrapping angle θ that is a central angle. Thus, when the steering roller 3 moves in an elongation and contraction direction 22, which is an example of a second direction, parallel to a bisector 21 of the wrapping angle θ, the fixing belt 1 elongates or contracts, and the tension of the fixing belt 1 is increased or decreased. In addition, when the steering roller 3 moves in a twist direction 23, which is an example of a first direction, being parallel to a perpendicular bisector of the bisector 21 and intersecting the bisector 21 of the wrapping angle θ, the fixing belt 1 is deformed so as to be twisted.

In Example 1, the component in the elongation and contraction direction 22 is set smaller than the component in the twist direction 23. That is, the component in the twist direction 23 and the component in the elongation and contraction direction 22 are the same when a tilt angle φ between a tilt direction 24 and the twist direction 23 is 45°, the component in the twist direction 23 is larger than the other when the tilt angle φ is 0° or more and less than 45°, and the component in the elongation and contraction direction 22 is larger than the other when the tilt angle φ is more than 45° and less than or equal to 90°. In Example 1, the tilt angle φ is set to around 14° so that the ratio between the component in the elongation and contraction direction 22 and the component in the twist direction 23 stands at 1:4, that is, the component in the elongation and contraction direction 22 is 25% relative to the component in the twist direction 23.

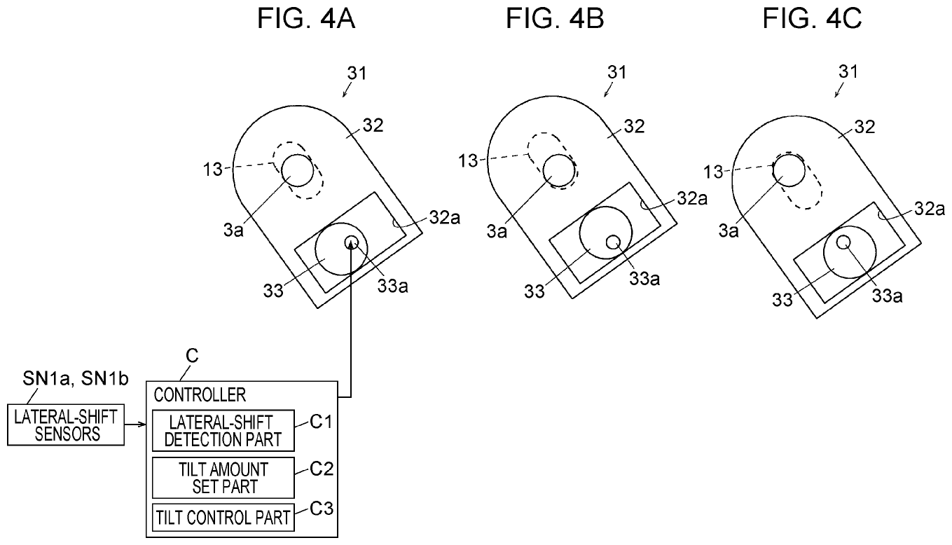

FIGS. 4A, 4B, and 4C illustrate a steering device of Example 1, that is, FIG. 4A illustrates a standby position, FIG. 4B illustrates an elongation-side maximum position, and FIG. 4C illustrates a contraction-side maximum position.

In FIG. 3 and FIGS. 4A to 4C, a steering mechanism 31, which is an example of a lateral-shifting correction member, is disposed at the front of the frame 11 on the front side. In FIGS. 4A to 4C, the steering mechanism 31 of Example 1 includes a slider 32, which is an example of a shaft supporter. The slider 32 is movable in a direction where the guide hole part 13 extends and rotatably supports a front end portion of the steering roller 3. A cam follower part 32a, which is an example of an operated part, is formed in a lower right portion of the slider 32. The cam follower part 32a of Example 1 has an opening.

In the cam follower part 32a, an eccentric cam 33, which is an example of an operating part, is accommodated. A motor (not illustrated), which is an example of a driving member, transmits drive to a rotating shaft 33a of the eccentric cam 33. Thus, when the eccentric cam 33 rotates with the rotation of the motor, the steering roller 3 becomes movable, along the guide hole part 13, between the standby position illustrated in FIG. 4A, the elongation-side maximum position illustrated in FIG. 4B, and the contraction-side maximum position illustrated in FIG. 4C.

In FIG. 3, on both sides, in the width direction, of the fixing belt 1, there are arranged lateral-shift sensors SN1a and SN1b, which are each an example of a detection member for detecting a lateral shift of the fixing belt 1.

### DESCRIPTION OF CONTROLLER OF EXAMPLE 1

In FIGS. 4A to 4C, the controller C, which is an example of a controller of the copier U, includes an input and output interface I/O that performs, for example, signal input and output relative to the outside of the copier U. The controller C further includes a read-only memory (ROM) that stores, for example, a program and information for executing required processing. The controller C further includes a random-access memory (RAM) for temporarily storing required data. The controller C further includes a central processing unit (CPU) that performs processing according to a program stored in, for example, the ROM. Thus, the controller C of Example 1 is constituted by an information processing device of miniature size, that is, a so-called microcomputer. Accordingly, the controller C enables various functions by executing a program stored in, for example, the ROM.

The controller C of Example 1, when a signal is input from a signal output element, performs control by outputting a signal to a controlled element.

Description of Signal Output Elements

Signals are input to the controller C from signal output elements such as the lateral-shift sensors SN1a and SN1b and other sensors, which are not illustrated.

Description of Controlled Elements

The controller C outputs signals to controlled elements such the power supply circuit E and the motor that brings the eccentric cam 33 into operation.

Function of Controller C

The controller C of Example 1 includes functional parts (such as a functional module and a program module) C1 to C3 described below.

A lateral-shift detection part C1 detects a lateral shift of the fixing belt 1 based on detection results of the lateral-shift sensors SN1a and SN1b. The lateral-shift detection part C1 of Example 1 also detects to which side the fixing belt 1 is shifted in the width direction, based on which sensor of the two lateral-shift sensors SN1a and SN1b detects an end portion of the fixing belt 1.

A tilt amount set part C2 sets a tilt amount by which the steering roller 3 is tilted. The tilt amount set part C2 of Example 1 enables the steering roller 3 to be tilted by a predetermined tilt amount by controlling the rotational amount of the eccentric cam 33. In Example 1, such a rotational amount is set so that the eccentric cam 33 is not rotated to the elongation-side maximum position (refer to FIG. 4B) and the contraction-side maximum position (refer to FIG. 4C), under circumstances where the cumulative number of prints of the copier U is small. The rotational amount of the eccentric cam 33 is increased according to an increase in the cumulative number of times of printing of the copier U. This is because, with the use of the copier U, inner surface oil is decreased over time, and generation of abrasion powder changes the coefficient of friction between the steering roller and the inner surface of the belt. Thus, the shifting correction performance is decreased if the rotational amount of the eccentric cam 33 is not changed, and the above-described operation is performed for addressing the problem.

A tilt control part C3 tilts the steering roller 3 in a direction where the extent of lateral shifting of the fixing belt 1 is reduced by controlling the motor that rotates the eccentric cam 33. When the lateral-shift sensors SN1a and SN1b detect any lateral shift of the fixing belt 1, the tilt control part C3 rotates the eccentric cam 33 according to the tilt amount set by the tilt amount set part C2. When a predetermined period of time has elapsed after no lateral shift of the fixing belt 1 is detected by the lateral-shift sensors SN1a and SN1b, the tilt control unit C3 rotates the eccentric cam 33 backward and returns the eccentric cam 33 to the standby position (refer to FIG. 4A).

### Operation of Example 1

In the fixing device F of Example 1 having the above-described configuration, the fixing belt 1 performs fixing by rotating during the image forming operation. When the fixing belt 1 shifts to one side in the width direction during the rotation of the fixing belt 1, the steering roller 3 is tilted by the steering mechanism 31, and such lateral shifting is corrected.

In recent years, image forming apparatuses have been reduced in size, and the fixing device F has also been reduced in size. When the fixing device F is reduced in size, there is a limit to reduction in the size of the heat generating roller 2 in relation to heat capacity. Thus, the diameter of the steering roller 3 has been reduced. Reduction in the diameter of the steering roller 3 makes smaller the region where the steering roller 3 is in contact with the fixing belt 1, that is, the wrapping angle. With such a small wrapping angle, even when the steering roller 3 is tilted to correct the lateral shifting, the fixing belt 1 is hardly moved in the width direction, and shifting correction performance is thereby decreased. Such a decrease in the shifting correction performance makes it impossible to correct the lateral shifting of the fixing belt 1, and the fixing belt 1 may thereby be damaged.

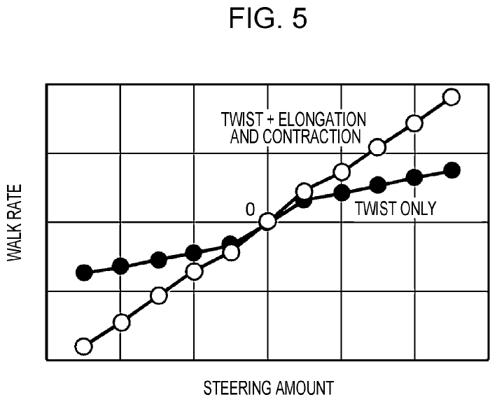

FIG. 5 illustrates an experimental example.

In FIG. 5, regarding the fixing device F of Example 1, there is observed correction performance (“walk rate” that is a movement amount in the belt width direction per one-meter rotation in a belt feeding direction) in the case where the movement direction of the steering roller 3 has only the component in the twist direction 23 and in the case where the movement direction of the steering roller 3 has, in addition to the component in the twist direction 23, the component in the elongation and contraction direction 22 being 25% of the total component in the movement direction. As FIG. 5 illustrates, the walk rate in the latter case is improved compared with the former case of the twist direction 23 only. In particular, it is confirmed that the walk rate is increased about twice when a steering amount (tilt amount of the steering roller 3) is increased.

Thus, as in Japanese Unexamined Patent Application Publication No. 2018-045255 and Japanese Unexamined Patent Application Publication No. 2021-056334, the shifting correction performance with the configuration where lateral shifting is corrected by tilting only in the twist direction 23 may be insufficient when the diameter of the steering roller 3 is reduced. In contrast, the capability to correct the lateral shifting of the fixing belt 1 in the width direction may be improved by the movement direction of the steering roller 3 having, in addition to the component in the twist direction 23, the component in the elongation and contraction direction 22 as in Example 1. Thus, in Example 1, even when the diameter of the steering roller 3 is reduced, it is possible to maintain the correction performance relative to the fixing belt 1.

Note that, in Example 1, the component in the elongation and contraction direction 22 is set smaller than the component in the twist direction 23. When the component in the elongation and contraction direction 22 is increased, the fixing belt 1 elongates and contracts to a greater degree. In particular, great force is required to elongate the fixing belt 1, and more force moving the steering roller 3 is thereby required. Thus, the motor for driving the eccentric cam 33 is required to be increased in size and capacity, and costs may thus be increased. In addition, because the tension of the fixing belt 1 is largely influenced, there arises a problem that the distribution of the tension varies between a front end region and a back end region of the steering roller 3. To address the above-described problems, in Example 1, the component in the elongation and contraction direction 22 is smaller than the component in the twist direction 23. Thus, compared with the case where the component in the elongation and contraction direction 22 is larger than the other, the steering roller 3 is capable of being moved by small force, and the influence on the distribution of the tension may be reduced in Example 1.

Moreover, in Example 1, based on the detection results of the lateral-shift sensors SN1a and SN1b, the steering roller 3 is automatically tilted, and the lateral shifting of the fixing belt 1 is automatically corrected. At this time, the tilt amount of the steering roller 3 is automatically corrected according to the long-term elongation of the fixing belt 1, that is, the long-term deterioration of the fixing belt 1. Thus, in Example 1, the shifting correction performance of the fixing belt 1 may be suppressed from being decreased over time and may be maintained for the long term.

### Example 2

Next, Example 2 of the present disclosure will be described. In the description of Example 2, the constituting elements corresponding to those of Example 1 are denoted by the same reference signs as those denoting the constituting elements of Example 1, and the detailed description of such constituting elements will be omitted.

Although differing from Example 1 in the following points, Example 2 has a configuration similar to that of Example 1 in the other points.

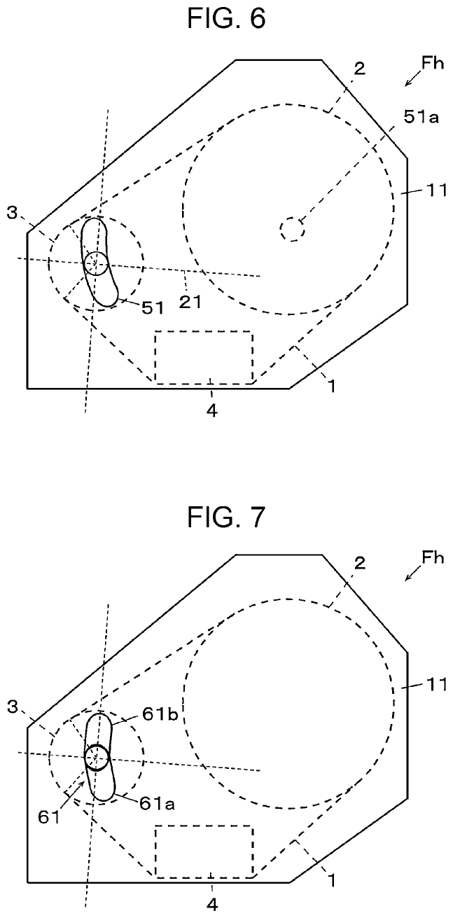

FIG. 6 illustrates a portion of a frame part of a fixing device of Example 2 and corresponds to FIG. 2 of Example 1.

In FIG. 6, instead of the long hole-shaped guide hole part 13 of Example 1, a heating unit Fh of Example 2 has a guide hole part 51 having an arc-shape. The guide hole part 51 of Example 2 is shaped along an arc having the center thereof at an arc center 51a. The arc center 51a is positioned off an extension of the bisector 21.

### Operation of Example 2

In the heating unit Fh of Example 2 having the above-described configuration, the arc center 51a is positioned off the bisector 21.

When the arc center is positioned on an extension of the bisector 21, the steering roller 3 moves in a way similar to the way where the steering roller 3 moves in a direction having only the component in the twist direction 23. In contrast, the movement of the steering roller 3 along the guide hole part 51, which extends along the arc having the center thereof at the arc center 51a positioned off the bisector 21, is a movement in a direction having the component in the elongation and contraction direction 22 in addition to the component in the twist direction 23. Thus, as in Example 1, the capability to correct lateral shifting of the fixing belt 1 may be increased with the heating unit Fh of Example 2.

### Example 3

Next, Example 3 of the present disclosure will be described. In the description of Example 3, the constituting elements corresponding to those of Example 1 are denoted by the same reference signs as those denoting the constituting elements of Example 1, and the detailed description of such constituting elements will be omitted.

Although differing from Example 1 in the following points, Example 3 has a configuration similar to that of Example 1 in the other points.

FIG. 7 illustrates a portion of a frame part of a fixing device of Example 3 and corresponds to FIG. 2 of Example 1.

In FIG. 7, instead of the long hole-shaped guide hole part 13 of Example 1, a heating unit Fh of Example 3 has a guide hole part 61 bent in the middle. The guide hole part 61 of Example 3 has a tilt portion 61a, which is an example of a second guide portion, extending in the tilt direction 24 and a twist portion 61b, which is an example of a first guide portion, extending in the twist direction 23. That is, the tilt portion 61a of the guide hole part 61 of Example 3 is the same as a portion of the guide hole part 13 of Example 1 whereas the twist portion 61b differs from any portion of the guide hole part 13 of Example 1. The tilt portion 61a defines a range where the fixing belt 1 contracts.

### Operation of Example 3

In the heating unit Fh of Example 3 having the above-described example, unlike Example 1, the force stretching the fixing belt 1 does not act when the steering roller 3 moves through the region of the twist portion 61b. When moving through the region of the tilt portion 61a, the steering roller 3 moves in a direction where the fixing belt 1 contracts, and the force stretching the fixing belt 1 does not act. Thus, in Example 3, with the guide hole part 61, the steering roller 3 is moved by small force compared with the guide hole part 13 of Example 1. In addition, the long-term elongation of the fixing belt 1 may be suppressed, and the long-term deterioration thereof may also be suppressed.

### Modifications

Although the examples of the present disclosure have so far been described in detail, the present disclosure is not limited to the above-described examples, and various modifications may be made within the scope of the present disclosure as described in the claims. Modifications (H01) to (H07) of the present disclosure are described below as examples.

(H01) Although the copier is described as an example of the image forming apparatus in the above-described examples, such a copier is not the only option, and the image forming apparatus may be constituted by, for example, a fax, a printer, or a multifunctional machine.

(H02) Although, in the above-described examples, the configuration where the developers of four colors are used is described as an example of the configuration of the image forming apparatus, such a configuration is not the only option, and the present disclosure may be applicable to, for example, a single-color image forming apparatus or a multi-color image forming apparatus where three or less colors or five or more colors are used.

(H03) The numerical values given as examples in the above-described examples may appropriately be changed according to designs and specifications.

(H04) Although, in the above-described examples, the configuration where the front and back ends of the steering roller 3 are movable by using the guide hole part 13 when lateral shifting is corrected is described as an example, such a configuration is not the only option. For example, only the front portion of the steering roller 3 may be moved while the back portion thereof is fixed, or the back portion of the steering roller 3 may be moved while the front portion thereof is fixed. Note that, as described in the examples, in the configuration where both the front and back ends of the steering roller 3 are movable along the guide hole parts, due to the symmetrical movement of the steering roller 3 about the center in the width direction of the steering roller 3, steering control is twice as efficient as steering control with the configuration where one side is fixed. In the configuration where one side is fixed, the belt stretch distances to the heating roller positioned upstream differs and the belt stretch distances to the fixing pad positioned downstream differs between a front region and a back region, and the walk rate toward the front surface the paper of a figure may thereby differ from the walk rate toward the undersurface of the paper of a figure.

(H05) Although the component in the elongation and contraction direction 22 is smaller than the component in the twist direction 23 in the above-described examples, such a configuration is not the only option. The component in the elongation and contraction direction 22 may be larger than the component in the twist direction 23.

(H06) Although the tilt amount of the steering roller 3 is corrected over time in the above-described examples, the tilt amount of the steering roller 3 is not necessarily corrected in such a manner.

(H07) Although, in the above-described examples, the configuration where the eccentric cam 33 is used for the steering mechanism 31 that tilts the steering roller 3 is described as an example, such a configuration is not the only option. Any configuration capable of moving the steering roller 3 may be adopted. For example, in Example 1, the configuration where the lateral-shift sensors SN1a and SN1b detect a lateral shift of the fixing belt 1, and the steering mechanism 31 actively rotates the steering roller 3, that is, a so-called active steering system is described as an example; however, such a configuration is not the only option. The system where the steering roller is tilted by receiving force (edge force) in the width direction of the belt due to the lateral shifting of the belt, that is, a so-called passive steering system (for example, refer to Japanese Unexamined Patent Application Publication No. 2014-10429) may be adopted.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A belt unit comprising:

a belt-shaped member being endless; and

a support member that supports the belt-shaped member and rotates, the support member having a rotating shaft that tilts in:
a tilt direction having a component in a first direction intersecting a bisector of a central angle of a wrapping range where the belt-shaped member is wrapped around the support member and a component in a second direction where the belt-shaped member elongates and contracts; and
a direction where extent of shifting of the belt-shaped member to one side in a width direction of the belt-shaped member is reduced.
   (((2)))

The belt unit according to (((1))), further comprising:

a guide part with which the rotating shaft of the support member is guided in the tilt direction.

(((3)))

The belt unit according to (((2))), wherein:

the guide part has:
a first guide portion that defines a range in a direction where the belt-shaped member elongates and with which the rotating shaft is guided in the first direction; and
a second guide portion that defines a range in a direction where the belt-shaped member contracts and with which the rotating shaft is guided in the tilt direction.
   (((4)))

The belt unit according to (((1))), further comprising:

a guide part with which the rotating shaft of the support member is guided in the tilt direction that is a circumferential direction around a rotation center positioned off the bisector.

(((5)))

The belt unit according to any one of (((1))) to (((4))), wherein:

the component in the second direction is smaller than the component in the first direction.

(((6)))

The belt unit according to any one of (((1))) to (((5))), further comprising:

a detection member that detects shifting of the belt-shaped member to one side in a width direction of the belt-shaped member; and

a controller that tilts the support member according to a detection result of the detection member.

(((7)))

The belt unit according to (((6))), wherein:

the controller adjusts a tilt amount of the support member according to a change in the shifting over time.

(((8)))

A fixing device comprising:

a belt unit including:
a belt-shaped member that comes into contact with a medium onto which toner is transferred and transports the medium while heating the toner; and
a support member that supports the belt-shaped member and rotates, the support member having a rotating shaft that tilts in:
   a tilt direction having a component in a first direction intersecting a bisector of a central angle of a wrapping range where the belt-shaped member is wrapped around the support member and a component in a second direction where the belt-shaped member elongates and contracts; and
   a direction where extent of shifting of the belt-shaped member to one side in a width direction of the belt-shaped member is reduced; and
a pressing member that faces the belt-shaped member and applies pressure to the medium while holding the medium between the pressing member and the belt-shaped member.
   (((9)))

An image forming apparatus comprising:

an image holding member that holds an image;

a transfer unit that transfers an image held by the image holding member onto a medium;

the fixing device that fixes an image transferred onto the medium, to the medium.

What is claimed is:

1. A belt unit comprising:
a belt-shaped member being endless; and
a support member that supports the belt-shaped member and rotates, the support member having a rotating shaft that tilts in:
a tilt direction having a component in a first direction intersecting a bisector of a central angle of a wrapping range where the belt-shaped member is wrapped around the support member and a component in a second direction where the belt-shaped member elongates and contracts; and
a direction where extent of shifting of the belt-shaped member to one side in a width direction of the belt-shaped member is reduced.

2. The belt unit according to claim 1, further comprising:
a guide part with which the rotating shaft of the support member is guided in the tilt direction.

3. The belt unit according to claim 2, wherein:
the guide part has:
a first guide portion that defines a range in a direction where the belt-shaped member elongates and with which the rotating shaft is guided in the first direction; and
a second guide portion that defines a range in a direction where the belt-shaped member contracts and with which the rotating shaft is guided in the tilt direction.

4. The belt unit according to claim 1, further comprising:
a guide part with which the rotating shaft of the support member is guided in the tilt direction that is a circumferential direction around a rotation center positioned off the bisector.

5. The belt unit according to claim 1, wherein:
the component in the second direction is smaller than the component in the first direction.

6. The belt unit according to claim 1, further comprising:
a detection member that detects shifting of the belt-shaped member to one side in a width direction of the belt-shaped member; and
a controller that tilts the support member according to a detection result of the detection member.

7. The belt unit according to claim 6, wherein:
the controller adjusts a tilt amount of the support member according to a change in the shifting over time.

8. A fixing device comprising:
a belt unit including:
a belt-shaped member that comes into contact with a medium onto which toner is transferred and transports the medium while heating the toner; and
a support member that supports the belt-shaped member and rotates, the support member having a rotating shaft that tilts in:
a tilt direction having a component in a first direction intersecting a bisector of a central angle of a wrapping range where the belt-shaped member is wrapped around the support member and a component in a second direction where the belt-shaped member elongates and contracts; and
a direction where extent of shifting of the belt-shaped member to one side in a width direction of the belt-shaped member is reduced; and
a pressing member that faces the belt-shaped member and applies pressure to the medium while holding the medium between the pressing member and the belt-shaped member.

9. An image forming apparatus comprising:
an image holding member that holds an image;
a transfer unit that transfers an image held by the image holding member onto a medium; and
the fixing device that fixes an image transferred onto the medium, to the medium.
